(19) United States
(12) Patent Application Publication
(10) Pub. No.: US 2025/0244046 A1
(43) Pub. Date: Jul. 31, 2025

(54) AIR HANDLER CONDENSATION MAINTENANCE SYSTEM

(71) Applicant: Steven Bolcar, Winter Garden, FL (US)

(72) Inventor: Steven Bolcar, Winter Garden, FL (US)

(21) Appl. No.: 18/427,528

(22) Filed: Jan. 30, 2024

(51) Int. Cl. F24F 13/22; C02F 1/50

(52) U.S. Cl. CPC F24F 13/222; C02F 1/50; C02F 2303/04; C02F 2303/20; F24F 2013/228

(57) ABSTRACT

An air handler maintenance system includes a storage container that is secured onto a side panel of an air handling unit. A chemical solution is housed within the storage container, and a drip valve is located along the bottom end of the container, and is connected to the first end of an elongated hose. A hollow sleeve is positioned through one wall of the drain pan of the air handler and the second end of the hose is positioned through the sleeve. Cleaning solution from the container is dispensed through the hose and onto the floor of the drain pan where it travels to the condensate drain line removing contaminants along the way. The amount of cleaning solution dispensed by the system is adjusted via the valve, and the container is transparent for determining the fluid level of the container.

### TECHNICAL FIELD

The present invention relates generally to residential HVAC systems, and more particularly to an air handler condensation maintenance system.

### BACKGROUND

The statements in this section merely provide background information related to the present disclosure and may not constitute prior art.

Residential HVAC systems include an air handler having a blower that passes air over a series of evaporator coils. During operation of the air handler, condensation is formed on the coils and is routed into a drain pain located beneath the coils. The pan is designed to collect and funnel the liquid into a condensate drain line for removal to a location outside the building.

Unfortunately, it is common for these drain lines to become clogged periodically due to algae, fungus and various airborne debris that enters the drain line from the drain pan. Although the frequency at which the drain line clogs vary based on how often a user changes the air filter, most drain lines eventually clog. When the drain line becomes clogged, water in the drain pan will continue to rise until either the air handler shuts off (if the system is equipped with a safety float switch), or until the water overflows from the pan. In an overflow situation, the water will spread to the surrounding area and can cause damage to the air handler housing, the surrounding drywall, the floors and/or any number of other components.

In either instance, when the condensate drain line becomes clogged, a user must typically hire an HVAC technician to perform a service on the unit which includes physically unclogging the condensate drain line, and perform a thorough cleaning of the drain pan, the evaporator coils and other system components. Such a requirement represents a significant expense and often results in the inability to run the AC unit for a period of time.

Accordingly, it would be beneficial to provide an air handler condensation maintenance system that can prevent the buildup of debris within condensation lines so as to overcome the drawbacks noted above.

### SUMMARY OF THE INVENTION

The present invention is directed to an air handler maintenance system. One embodiment of the present invention can include a storage container having a watertight inside space and a connector for being secured onto a side panel of an air handling unit. A chemical solution can be housed within the storage container and can be formulated to attack microorganisms and other contaminants from the air handlers drain pan and condensate drain line.

In one embodiment, a drip valve is located along the bottom of the container and is connected to the first end of an elongated hose. A hollow sleeve is positioned through a wall of the drain pan and the second end of the hose is positioned through the sleeve. Cleaning solution from the container is dispensed through the hose so as to be deposited onto the drain pan where it will travel through the drain line removing contaminants along the way. The amount of cleaning solution dispensed by the system can be adjusted by the valve, and the container can be transparent so as to allow a user to see the fluid level of the container at all times.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of an air handler maintenance system that is useful for understanding the inventive concepts disclosed herein.

FIG. 2 is a partial cutout view of the air handler maintenance system of claim 1, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples of connectors include, but are not limited to, thread-to-connect, twist-to-connect, and push-to-connect type devices, opposing strips of hook and loop material (e.g., Velcro®), attractively oriented magnetic elements or magnetic and metallic elements, buckles such as side release buckles, clamps, sockets, clips, carabiners, and compression fittings, for example. Each illustrated connector and complementary connector can be permanently secured to the illustrated portion of the device via a permanent sealer such as glue, adhesive tape, or stitching, for example.

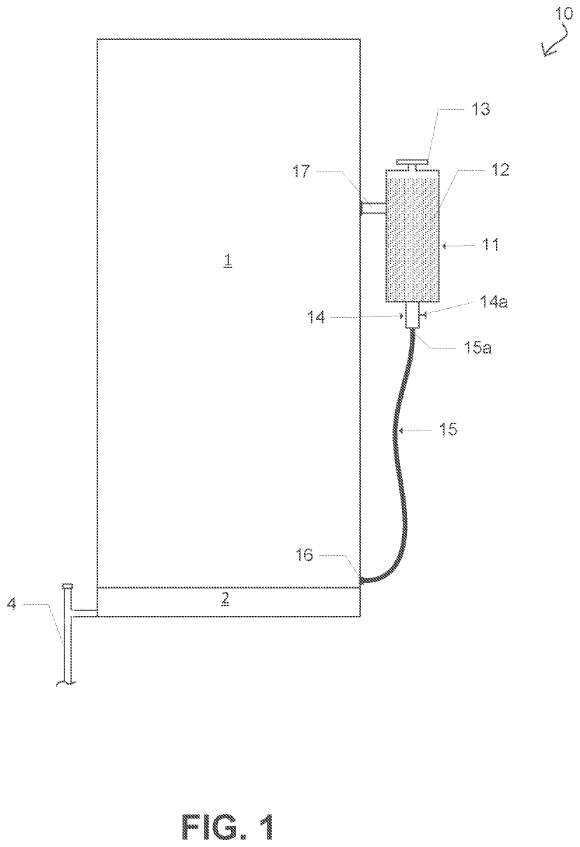

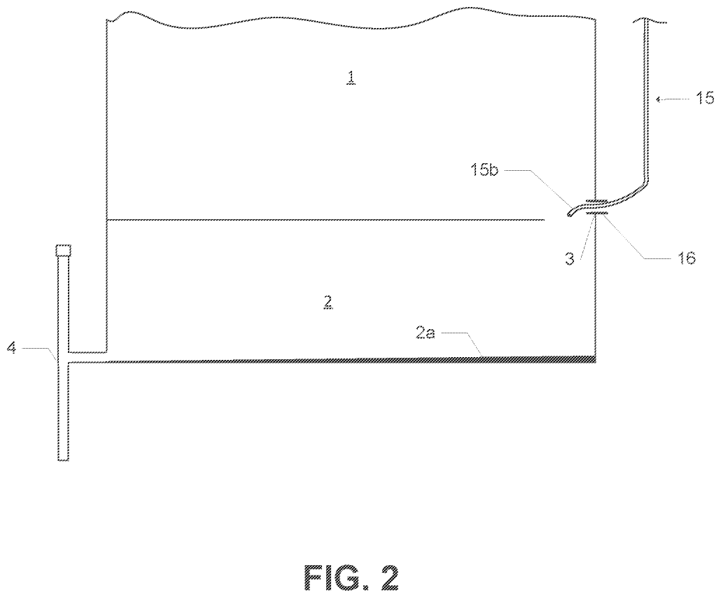

FIGS. 1 and 2 illustrate one embodiment of an air handler condensation maintenance system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, the system 10 can include, essentially, a storage container 11, an adjustable valve 14, a supply hose 15 and a sleeve 16. The system can be secured onto the outside wall of an air handler 1 via the connector 17, and can function to supply a cleaning agent 12 directly onto the drain pan 2 of the air handler. When so provided, the solution will eliminate particulates in the drain pan, thereby preventing clogging of the condensate drain line 4.

As described herein, the storage container 11 can include any number of different shapes and sizes for forming a watertight interior space into which a cleaning solution 12 can be stored. In the preferred embodiment, the container will include a removable cap 13 along the top end for allowing a user to refill the container with cleaning solution as needed. However, other embodiments are contemplated wherein the container does not include a removable cap, and instead is provided as a one-time-use device that is pre-filled with the cleaning solution. In such an embodiment, the container will be replaced upon dispensing the stored cleaning solution as described below.

In either instance, the container 11 will preferably be constructed from a durable watertight and transparent material such as polyethylene terephthalate (PET), polycarbonate (PC), and high density polyethylene (HDPE) plastics, for example, so as to allow a user to visually see the level of cleaning solution stored within the container at a glance. In this regard, the container may be rigid or malleable in nature, and will be ideally able to store 1 liter of cleaning solution. Of course, any number of other materials, and capacities are also contemplated.

As described herein, the cleaning solution 12 can include, comprise or consist of any type of chemical composition such as a biocide solution capable of destroying, deterring or rendering harmless any harmful organism by chemical or biological means. Likewise, the solution may include any chemical substance, or combination of substances capable of eliminating the growth of microorganisms, algae, gunk and/or solid particulates that develop on or within the drain pan and condensate line of the air handler.

In one embodiment, an adjustable drip valve 14 is connected to the bottom surface of the container 11. The valve can include a knob 14a or other adjustment mechanism for allowing a user to adjust the amount of cleaning solution permitted to pass through the valve into the first end 15a of the supply hose 15 connected to the other end of the valve. In this regard, the knob can include functionality for allowing the system to dispense measured amounts of cleaning solution such as 1 ounce, per day, for example.

Although described above with regard to a purely mechanical valve system for dispensing a specific amount of solution, other embodiments are also contemplated. To this end, one embodiment is contemplated wherein the valve comprises a battery operated valve capable of automatically opening and closing in order to selectively dispense the cleaning solution based on a user-defined daily or hourly flow rate.

In one embodiment, the supply hose 15 can include a ⅜ inch internal diameter plastic tube having a length of about 4 feet; however, any number of other lengths, diameters, and construction materials suitable for receiving the cleaning solution without having a chemical reaction to the same are also contemplated.

In operation, the container 11 can be removably connected onto the outside wall of the air handler 1, ideally on the opposite side of the condensate drain line 4; however any number of locations are contemplated. In one embodiment, the container can be secured onto the air handler via one or more connectors 17 such as the illustrated magnetic clip, for example; however, any number of other types of connectors capable of positioning the container onto the air handler in either a permanent or removable fashion are also contemplated.

Next, the user can drill an opening 3 through the sidewall of the air handler body. In the preferred embodiment, the hole will be drilled at a location at least 1 inch above the top of the drain pan 2. Once the hole is drilled, an elongated hollow sleeve 16 can be positioned through the opening. As shown, the sleeve will include an inside dimension that is complementary to the outside dimension of the hose, so as to permit the second end of the hose 15b to slide through the sleeve. When so positioned, the end of the hose will be located above the floor of the drain pan.

Because air handler bodies are constructed from thin (e.g., 1-2 mm) sheet metal, the sleeve 16 is an important component to prevent the hose from being cut or otherwise damaged by the sharp edges of the air handler body caused by the creation of the opening. The sleeve may be constructed from any number of rugged materials such as metal or hard plastic, for example.

Of course, other embodiments are contemplated wherein the sleeve is replaced with a connector conduit such as a ⅜ inch plastic screw-in connector conduit fitting that is commercially available from Southwire INC, for example. Such a feature can securely position the hose through the air handler body while allowing the cleaning agent to engage the drain pan.

Because the system dispenses the cleaning solution via a gravity feed, it is important that the storage container be positioned above the drain pan, and that no portion of the hose is positioned lower than the second end 15b. As such, during installation of the system, the user may cut the length of the hose as needed.

In either instance, once the system is installed, the user can adjust the knob 14a of the valve to begin dispensing a measured amount of the cleaning solution into the hose where it will flow down until exiting the second end of the hose into the drain pan. As the solution flows along the angled surface of the drain pan, it will attack any existing contaminants located in the pan and will continue to the condensate drain. Once entering the drain line, the solution will continue to attack and remove any contaminants, thus preventing the same from clogging. After a few days or weeks, the user can inspect the drain pan for the accumulation of contaminants, and can adjust the amount of cleaning solution being dispensed based on the results of the inspection.

Accordingly, by providing a system that continuously provides a cleaning solution to the drain pan, the buildup of contaminants causing clogs within the condensation drain line will be eliminated, thus ensuring smooth and continuous operation of the HVAC system. Moreover, each month when the user replaces the filter, they can inspect the fluid level of the container and refill or replace the same as needed.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a storage container having an interior space;
a cleaning agent that is stored within the storage container; and
an elongated hose having a first end that is in fluid communication with the storage container,
wherein a second end of the hose is configured to be positioned above a drain pan located within the air handling unit, and the second end of the hose is configured to dispense the cleaning agent directly into the drain pan.

2. The system of claim 1, further comprising:
a cap that is removably positioned along the storage container, said cap functioning to provide access to the interior space to refill the cleaning agent.

3. The system of claim 1, further comprising:
an elongated hollow sleeve having an inside diameter that is complementary to an outside diameter of the hose.

4. The system of claim 3, wherein the sleeve is configured to be positioned through a hole in the air handler body.

5. The system of claim 4, wherein the second end of the hose is configured to be positioned through the sleeve such that an opening in the second end of the hose is above the floor of the drain pan.

6. The system of claim 1, wherein the cleaning solution comprises a biocide solution.

7. The system of claim 1, wherein the storage container is permanently secured onto the air handler unit at a location above the drain pan.

8. The system of claim 1, wherein the storage container is removably secured onto the air handler unit at a location above the drain pan.
